(19) United States
(12) Patent Application Publication
(10) Pub. No.: US 2004/0130146 A1
(43) Pub. Date: Jul. 8, 2004

(54) Wine must tee

(76) Inventor: Todd A. Mays, Ben Lomond, CA (US)

Correspondence Address: Henneman & Saunders, 714 W. Michigan Ave., Three Rivers, MI, 49093, US

(21) Appl. No.: 10/662,993

(22) Filed: Sep. 15, 2003

Related U.S. Application Data
(60) Provisional application No. 60/410,379, filed on Sep. 13, 2002.

(51) Int. Cl. F16L 39/00

(52) U.S. Cl. 285/133.11

(57) ABSTRACT

A pipe fitting includes a run tube having a cylindrical wall defining a first end opening, a second end opening, and an elongated throat, a branch tube fitting defining a fluid passage, and a tapered throat section fixed between the elongated throat opening and the branch tube fitting. Optionally, there is a branch tube interposed between the throat section and the branch tube fitting. The first end opening and the second end opening also can include fittings. The run tube, in combination with the throat section defines a body having a generally triangular inner chamber. The pipe fitting prevents clogging in piping systems transporting liquid/solid mixtures, such as in a winery. Clogs are prevented because the cross sectional area of the throat opening is substantially (e.g., at least 1.25) larger than the cross sectional area of the fluid passage defined by the branch tube fitting.

### RELATED APPLICATIONS

This application is a continuation-in-part of U.S. Provisional Patent Application Serial No. 60/410,379, filed Sep. 13, 2002, by the same inventor, which is incorporated herein by reference in its entirety.

### BACKGROUND OF THE INVENTION

1. Field of the Invention

This invention relates generally to piping system components, and more particularly to a tee fitting having an enlarged throat section that prevents clogging. Even more particularly, this invention relates to a tee fitting for use in a winery piping system that prevents clogging when wine must is pumped therethrough.

2. Description of the Background Art

FIG. 1 shows a prior art tee fitting 100. Tee fittings, such as tee fitting 100, are commonly used to connect several pipes (typically 3) of a piping system together. Tee fitting 100 includes a run tube 102 and a branch tube 104, both of which are straight and generally cylindrical and are joined (e.g., welded) together using a saddle joint 106. Run tube 102 defines a first end opening 108 and a second end opening 110, and branch tube 104 defines a branch opening 112. Each of first end opening 108, second end opening 110, and branch opening 112 allow fluid to flow into or out of run tube 102 and/or branch tube 104. Additionally, run tube 102 has a centerline 114, and similarly, branch tube 104 has a centerline 116. Branch tube 104 is joined to run tube 102 at a 90-degree angle both at its centerline, as indicated by the orthogonal orientation of centerlines 114 and 116, and at its lateral edges 118.

A primary drawback inherent in a direct orthogonal connection of run tube 102 and branch tube 104 is the limited area of the internal throat opening between run tube 102 and branch tube 104 through which fluid can flow. The area of the throat opening from run tube 102 into branch tube 104 is generally circular and is limited in size to approximately the cross-sectional area of branch tube 104 at saddle joint 106. Even though saddle joint 106 increases the area of the throat opening slightly by introducing a radius of curvature 120, flow area through the throat is still substantially limited because the throat area is only a few percent larger than the cross sectional area of the branch tube. To the inventor's knowledge, conventional tee fittings have a radius of curvature of 1.5D or less. Because reducing the radius of curvature reduces the overall size of the fitting, the smallest possible radii of curvature that can be easily manufactured have been preferred in the prior art.

As a result of having a small throat opening, tee fittings like tee fitting 100 often clog when liquid/solid mixtures are passed through them. Wine must is one example of a liquid/solid mixture that often clogs tee fittings in winery piping systems. Wine must contains whole and crushed grape berries, seeds, skins, and juice. Since red wine is fermented as must, pumping the must from crushing stations to fermentation tanks often results in winery piping becoming clogged. Removing the clog from the tee fitting typically requires that the piping system be opened, thereby introducing a risk of contamination. Removing clogs is also labor intensive, and interrupts the production process, and is therefore costly to the winery. On the other hand, tee fittings are useful in piping systems, because they facilitate effective joining and routing of pipes.

What is needed, therefore, is a tee fitting that resists clogging when a liquid/solid mixture, including but not limited to wine must, passes therethrough.

### SUMMARY

The present invention overcomes the problems associated with the prior art, by providing a tee fitting having a tapered throat section interposed between the run tube and the branch tube, which prevents clogging of wine must and other liquid/solid mixtures flowing therethrough.

A pipe fitting of the present invention includes a run tube having a cylindrical wall defining a first end opening, a second end opening, and an elongated throat opening. The fitting also includes a branch tube fitting defining a fluid passage, and a tapered throat section connected between the elongated throat opening and the branch tube fitting. In a particular embodiment, the throat opening extends a majority of the length of the run tube. Clogs are prevented because the cross sectional area of the elongated throat opening is at least 1.25 times greater than the cross sectional area of the fluid passage. In one particular embodiment, the first end opening of the run tube is parallel to the second end opening. Additionally, the first end opening and second end opening can each include a fitting, such as a flange retained by a collar, for connecting either of them to a system. In another particular embodiment, a branch tube is interposed between the throat section and the branch tube fitting. Optionally, the branch tube includes a collar for retaining a fitting, such as a flange, about the fluid passage. Finally, the tee fitting of the present invention can be used in a winery piping system, and in which case, would be fabricated from stainless steel.

In a particular embodiment, the throat section includes front and back walls which are tangentially coupled to the run tube. If a branch tube is interposed between the throat section and the branch tube fitting, the front wall and back wall are also coupled to the branch tube as well. Optionally, the front and back walls are flat. In another particular embodiment, the throat includes a first side wall and a second side wall that define a radius of curvature.

Another pipe fitting of the present invention includes a body defining a generally triangular inner chamber, and has three connectors, each coupled to a respective corner of the triangular chamber for providing fluid communication with the chamber. The body defines three fluid passages each in communication with a respective one of the connectors. The body further defines a radius of curvature between two adjacent fluid passages. In a particular embodiment, the fluid passages, are generally circular and the radius of curvature is at least 1.5 times the diameter of the largest one of the fluid passages. In another particular embodiment, the radius of curvature is infinite. Optionally, a tube can be interposed between any one of the connectors and an associated corner of the chamber. In a particular embodiment, the connectors are flanges, which can be retained by a collar coupled to the body.

Yet another pipe fitting of the present invention includes a tube having a cylindrical wall defining a first end opening, a second end opening, and a throat opening. The fitting also includes a connector defining a fluid passage, and a throat section coupled between the throat opening and the connector, wherein a cross sectional area of the throat opening is at least 1.25 times greater than a cross-sectional area of the fluid passage. The throat section, in combination with a portion of the tube, creates a generally triangular inner chamber. In one particular embodiment, the cross sectional area of the throat opening is at least 2 times greater than the cross sectional area of the fluid passage, and in another, the cross sectional area of the throat opening is at least 3 times greater than the cross sectional area of the fluid passage. Optionally, either of the first end opening and the second end opening can include a connector for connecting the opening to a piping system.

### BRIEF DESCRIPTION OF THE DRAWINGS

The present invention is described with reference to the following drawings, wherein like reference numbers denote substantially similar elements:

FIG. 1 shows a tee fitting of the prior art;

FIG. 2 is a perspective view of a tee fitting of the present invention;

FIG. 3 is a front view of the tee fitting of FIG. 2;

FIG. 4 is a side view of the tee fitting of FIG. 2;

FIG. 5 is a section view looking into the tapered throat section of the tee fitting of FIG. 2;

FIG. 6 is a table summarizing possible dimension data for different sized tee fittings of the present invention;

FIG. 7 shows a front view of an alternate embodiment of a tee fitting according to the present invention; and

FIG. 8 shows a side view of the tee fitting of FIG. 7.

### DETAILED DESCRIPTION

The present invention overcomes the problems associated with the prior art, by providing a tee fitting that prevents clogging of liquid/solid mixtures flowing therethrough, such as wine must. In the following description, numerous specific details are set forth (e.g., flanges, collars, dimensions, specific materials, etc.) in order to provide a thorough understanding of the invention. Those skilled in the art will recognize, however, that the invention may be practiced apart from these specific details. In other instances, details of well known plumbing components (e.g., bolts and gaskets for fastening flanges together) and manufacturing techniques (welding, soldering, extruding, etc.) have been omitted, so as not to unnecessarily obscure the present invention.

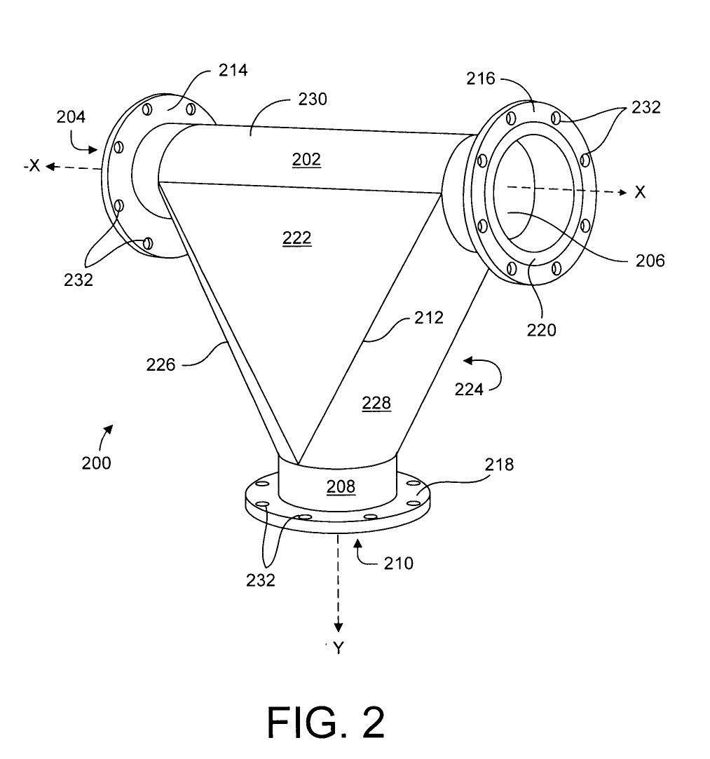

FIG. 2 shows a tee fitting 200 of the present invention. Tee fitting 200 includes a generally cylindrical run tube 202, a first end opening 204 (hidden in the present view), a second end opening 206, a cylindrical branch tube 208 defining a branch opening 210, and a tapered throat section 212 coupling run tube 202 with branch tube 208. Additionally, a first flange 214 surrounds first end opening 204, a second flange 216 surrounds second end opening 206, and a third flange 218 surrounds branch opening 210. Finally, each flange is retained about its respective opening by a collar fixed to the opening. For example, a collar 220 is shown retaining flange 216 about opening 206.

The particular sections of tee fitting 200 are positioned and function as follows. First end opening 204 and second end opening 206 are located at the distal ends of run tube 202 and each facilitate the flow of fluid into or out of tee fitting 200. Similarly, branch opening 210 is formed in a distal end of branch tube 208 and also facilitates the flow of fluid into or out of tee fitting 200. The expanded end of throat 212 is coupled at an elongated throat opening (not shown) that runs the majority of the length of run tube 202. Throat 212 is generally triangular and tapers away from run tube 202 to where it is coupled (e.g., welded) to branch tube 208 at its narrow end. Throat section 212 prevents clogging of tee fitting 200. Finally, branch tube 208 is oriented perpendicular (Y-direction) to run tube 202 (X-direction) at the center of run tube 202. It should be noted that depending on the application, branch tube 208 can be oriented obliquely as well.

Throat 212 is fabricated from several members including a front wall 222, a back wall 224 (shown in FIG. 4), a first side wall 226, and a second side wall 228. Note that the front wall 222 of throat 212 is flat and triangular, and lies in a plane tangent to run tube 202. Rear wall 224 is substantially similar to front wall 222.

Throat 212 is coupled to run tube 202 as follows. The bottom section of run tube 202 is removed, leaving an arcuate top wall 230 of run tube 202. Removing the bottom section of run tube 202 creates an elongated throat opening that is welded along its front edge to the top edge of front wall 222, and along its back edge to the top of back wall 224. Side walls 226 and 228 are also arcuate in shape (although may be flat), and are welded to the lateral edges of front wall 222 and rear wall 224 of throat 212. Additionally, the tops and bottoms of side walls 226 and 228 must be cut to match the curvature of run tube 202 and branch tube 208, respectively. When throat 212 is fixed to top wall 230, a body is formed having a generally triangular inner chamber having three fluid passages, each in fluid communication with a respective one of first opening 204, second opening 206, and branch opening 210. Although throat 212 is fabricated by welding several different pieces together, it is anticipated that throat 212 could be formed from any other suitable manufacturing process, for example die casting.

Throat 212 prevents clogging of tee 200 by substantially enlarging the internal cross-sectional area of the junction (i.e., the throat opening) between run tube 202 and branch tube 208 beyond the cross-sectional area of branch tube 208 and branch opening 210. In the present embodiment, the internal cross sectional area of the throat opening is more than 3 times larger than the cross sectional area of branch tube 208. In contrast, in prior art extrusion fittings, the opening at the junction between the run tube and the branch tube is only slightly larger (a few percent at most) than the opening of the branch tube.

Another way to characterize throat 212 is to consider the radius of curvature joining adjacent sides of branch tube 208 and run tube 202. In the embodiment of FIG. 2, first and second side walls 226 and 228 are straight, providing the minimal possible restriction of fluid flowing through throat section 212. Straight side walls 226 and 228 correspond to an infinite radius of curvature between the side edge of branch tube 208 and the bottom edge of run tube 202. However, the scope of the invention is considered to include fittings having radii of curvatures between branch tube 208 and run tube 202 of greater than 1.5D (i.e., 1.5 times the diameter of branch tube 208 or run tube 202). It is expected that instances of clogging will decrease as the radius of curvature increases.

Flanges 214, 216, and 218 permit tee fitting 200 to be removably connected to a piping system when each is fastened to a complementary flange of the system. Flanges 214, 216, and 218 each have eight fastening apertures 232(1-8) formed therein for receiving fasteners (e.g., bolts) therethrough. The collars (e.g., collar 220) surrounding each of their respective openings of tee fitting 200 absorb the tensile force exerted by flanges 214, 216, and 218 when tightened, thereby forming a leak-free coupling to the system.

It should be noted that when tee fitting 200 is used in a winery piping system, it is fabricated from stainless steel to prevent contamination of the wine must and its ingredients. It should also be noted that tee fitting 200 can be used in any piping system where clogging within tee fittings is a problem (e.g., food production factories and canneries, paper-mills, etc).

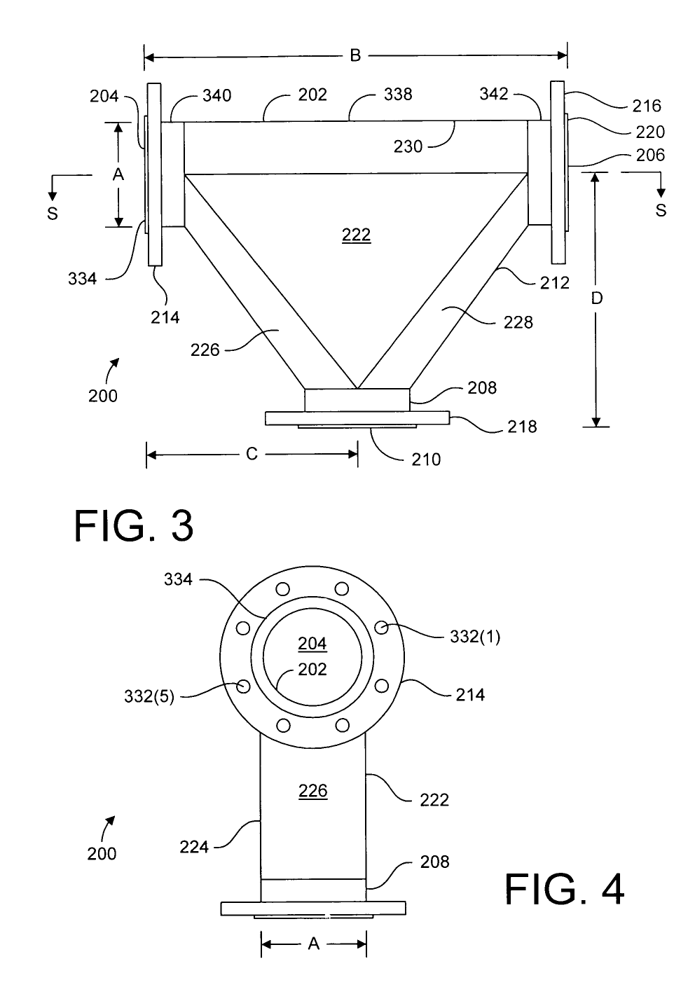

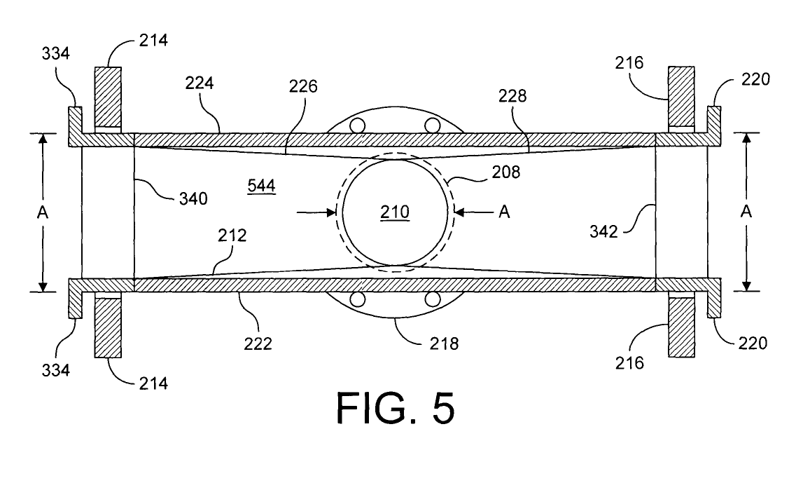

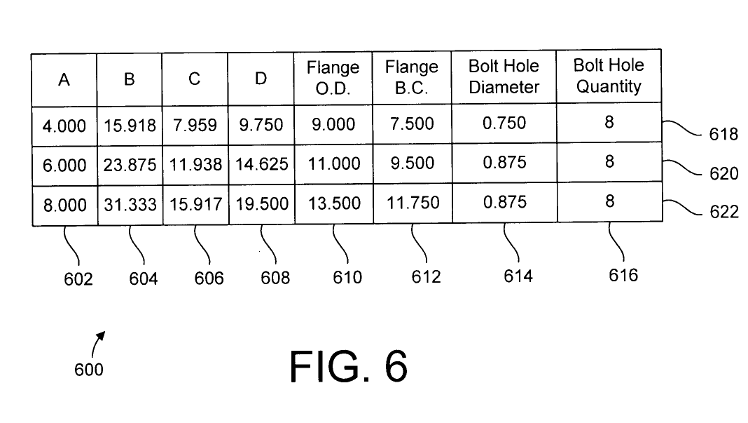

FIG. 3 shows a front view of tee fitting 200 including a collar 334 surrounding first end opening 204 and a collar 336 surrounding branch opening 210. Collars 334 and 336 retain flanges 214 and 218 about first end opening 204 and branch opening 210, respectively. Additionally, a section line S-S axially bisects run tube 202, a more detailed section drawing of which is shown in FIG. 5. Finally, a plurality of dimensions, A, B, C, and D, are labeled, which correspond to the data shown in the table of FIG. 6.

In the present embodiment, run tube 202 is composed of three defined sections including a center section 338, a left section 340, and a right section 342. Center section 338 is approximately equal in length to the throat opening formed in run tube 202. Center section 338 covers the top portion of throat section 212. Left section 340 of run tube 202 is coupled to front wall 222, back wall 224, first side wall 226, and center section 338 of run tube 202, thereby spacing flange 214 and collar 334 slightly away from throat 212. Similarly, right section 342 of run tube 202 is coupled to front wall 222, back wall 224, second side wall 228 and center section 338 of run tube 202, and spaces flange 216 and collar 220 away from throat section 212.

In this particular embodiment, tee fitting 200 is generally triangular in shape, and has a generally triangular inner chamber defining three openings (fluid passages), each at a respective corner of the chamber and in fluid communication with the inner chamber. Note that other types of connectors can be substituted for the flange-type connectors of the disclosed embodiment. As another option, tee fitting 200 could be directly coupled (e.g., welded) to a piping system thereby eliminating the need for such connectors or fittings.

FIG. 4 shows a side view of tee fitting 200 looking into first end opening 204. Branch tube 208 is shown to have the same diameter, A, as run tube 202 (FIG. 3). Because branch tube 208 is the same diameter as run tube 202, front wall 222 and back wall 224 can be attached tangent to run tube 202 and be parallel to one another. Branch tube 208 can have a larger or smaller diameter than run tube 202, but such a modification would necessitate angling front and back walls 222 and 224, as well as, requiring the overall size of throat 212 to be adjusted. Additionally, the sizes of first end opening 204 and/or second end opening 206 can also be modified.

FIG. 5 is a section view of tee fitting 200 taken along section line S-S of FIG. 3, and looking down throat section 212 into branch tube 208. Section line S-S is taken through the junction of throat section 212 and run tube 202. A throat opening 544 is defined in run tube 202 by the inner sides of left and right sections 340 and 342 of run tube 202, and by the junction of front and back walls 222 and 224 with run tube 202 (e.g., the tops of walls 222 and 224 in the present view). Throat opening 544 is a semi-cylindrical opening that is formed in run tube 202 by cutting a portion from the bottom of run tube 202. It is readily apparent that the cross sectional area of throat opening 544 is much larger than the cross-sectional area of branch tube 208 and would be much more effective at preventing clogs than the tee fittings of the prior art.

Also in FIG. 5, several structural features of tee fitting 200 are shown in better detail. For instance, collar 334 is formed in the outer edge of left section 340 after flange 214 is positioned onto run tube 202. Collar 220 is similarly formed in the outer edge of right section 342 of run tube 202. Furthermore, flange 214 and flange 216 are free to slide and rotate about their respective left and right sections 340 and 342 of run tube 202. Flange 218 can similarly slide and rotate about branch tube 208, permitting easy alignment with a complementary flange of a piping system.

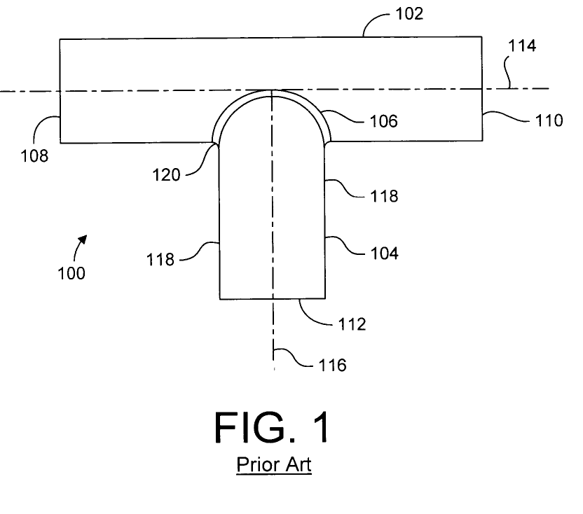

There are several factors which determine the size of throat opening 544 and, therefore, the size of tee fitting 200 itself. For example, in the present embodiment, throat opening 544 has more than three (3) times the cross sectional area of branch tube 208. Also, throat section 212 is approximately two-thirds (⅔ ) as high (Y-direction of FIG. 1) as run tube 202 is long in order to increase the internal volume of throat section 212, which helps disperse solid particles and prevent clogging. Thus, increasing the size of throat opening 544 and the height of throat section 212 will enlarge tee fitting 200, but will eliminate or greatly reduce any instances of clogging.

On the other hand, the size of tee fitting 200 can be reduced in several ways to fit smaller spaces. For instance, throat section 212 can be shortened to reduce the overall height of tee fitting 200, however, it is expected that the tee fitting would then be more proned to clogging. Alternately, the cross sectional area of throat opening 544 can be reduced to sizes as small as 1.25 times the cross sectional area of branch opening 210 and still provide a significant advantage over the tee fittings of the prior art. In either case, with reduction in size of either the height of throat section 212 or the cross sectional area of throat opening 544, there is increased risk of clogging with the tee fitting. The exact size of tee fitting 200 and throat opening 544 is customizable for different applications.

The shape of side walls 226 and 228 can also be altered. In the present embodiment, side walls 226 and 228 are substantially straight from run tube 202 to branch tube 208, corresponding to an infinite radius of curvature between adjacent sides of run tube 202 and branch tube 208. Optionally, the radius of curvature of side walls 226 and 228 can be variably decreased down to about 1.5D (i.e., 1.5 times the diameter of run tube 202 or branch tube 208) to alter the size and/or shape of tee fitting 200.

FIG. 6 shows a table 600 summarizing key dimensions and manufacturing data for various sizes of tee fitting 200. Table 600 includes columns 602, 604, 606, 608, 610, 612, 614, and 616 that each contain dimension and manufacturing data found suitable by the inventor. Rows 618, 620 and 622 each correspond to a particular one of three different sizes of tee fitting. Row 618 corresponds to a small tee fitting, row 620 to a medium sized tee fitting, and row 620 to a large tee fitting. All dimensions given in table 600 are in U.S. Standard inches.

Columns 602, 604, 606, and 608 list particular dimensions for different tee fittings 200 corresponding by letter (e.g., A, B, C, and D) to the dimensions shown in FIGS. 3-5 and 7-8. Column 602 lists possible outer diameters for run tube 202 and branch tube 208. Column 604 lists possible lengths (including collars 334 and 220) of run tube 202, and column 606 gives the distances from an end of run tube 202 to the center of branch tube 208. Finally, column 608 represents the distance from the center of run tube 202 to the bottom of branch tube 208 (including collar 336).

Furthermore, columns 610, 612, 614, and 616 list dimensions and other manufacturing data for flanges 214, 216, and 218. Column 610 lists outer flange diameters for each tee size. Column 612 lists the distance between bolt hole centers of two opposite bolt holes. For example, with reference to FIG. 4, if tee fitting 200 were a small tee fitting (e.g., corresponding to row 618) the distance between bolt hole 332(1) and 332(5) would be 7.500 inches. Column 614 lists the diameters of bolt holes 332(1-8) for each flange size, and column 616 lists the number of bolt holes 332(1-8) per flange. Finally, it should be noted that the inner diameter of each of flanges 214, 216, and 218, although not specified, is slightly larger than the diameter of run tube 202 or branch tube 208, but smaller than the diameter of the collar (e.g., collars 220, 334, and 336) that retains them.

A tee fitting has been manufactured with the dimensions of the medium tee fitting corresponding to row 620 of table 600. The tee fitting was fabricated from type 304 stainless steel, and was hydrostatically pressure tested to 180 psi successfully at an ambient temperature of 72 degrees Fahrenheit.

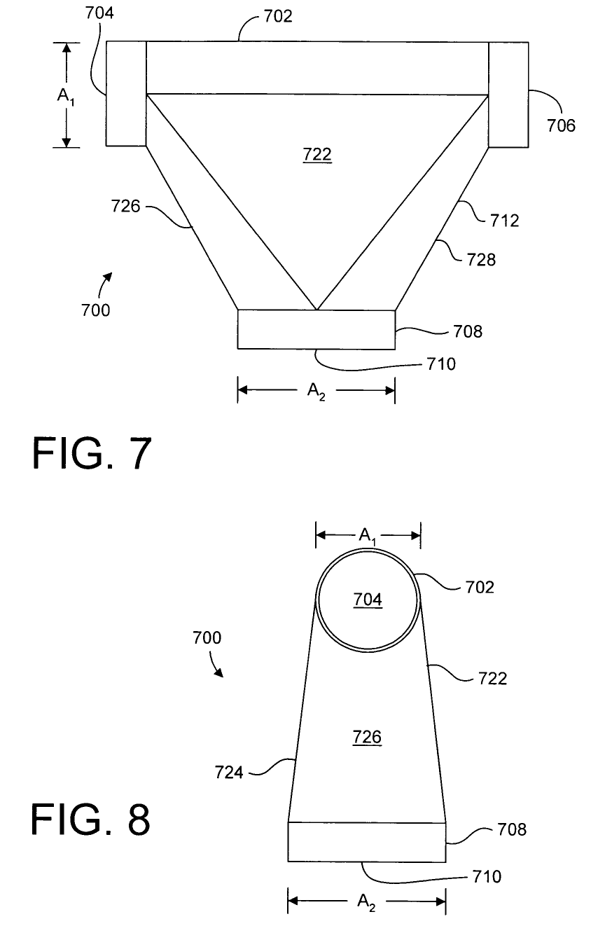

FIGS. 7 and 8 show front and side views, respectively, of an alternate tee fitting 700 of the present invention. Tee fitting 700 includes a generally cylindrical run tube 702 having a first end opening 704 and a second end opening 706. First end opening 704 and second end opening 706 each facilitate fluid flow into or out of tee fitting 700. Tee fitting 700 also includes a branch tube 708 defining a branch opening 710, which also facilitates fluid flow into or out of tee fitting 700.

A tapered throat section 712 is interposed between run tube 702 and branch tube 708. Throat section 712 connects to run tube 702 at an elongated throat opening (not shown), and prevents clogging of tee fitting 700 when a liquid/solid mixture (e.g., wine must) is pumped therethrough. Throat section 712 is formed from a front wall 722, a back wall 724 (FIG. 8), a first side wall 726, and a second side wall 728, all of which are welded together in the present embodiment.

Tee fitting 700 is similar to tee fitting 200 of FIG. 2, except that branch tube 708 has a larger than run tube 702. Because branch tube 708 has a larger diameter (A₂) than the diameter (A₁) of run tube 202, the shape of throat section 712 is different from the shape of throat section 212. First, front wall 722 and back wall 724 are angled out (and optionally lengthened) to accommodate the larger diameter of branch tube 708, but still engage run tube 702 at its outer edges. Additionally, side walls 726 and 728 become larger near branch tube 708. Alternately, side walls 724 and 726 could remain generally uniform in shape with modification of the size and shape of front wall 722 and back wall 724.

Tee fitting 700 is also different from fitting 200 in that it does not have flanges and collars around end openings 704, and 706, and branch opening 710. Instead, tee fitting 700 is designed to be permanently connected to a piping system, for example by welding.

The description of particular embodiments of the present invention is now complete. Many of the described features may be substituted, altered or omitted without departing from the scope of the invention. For example, the flange and collar surrounding each tube opening can be eliminated and/or replaced by different type firings. Furthermore, additional inlet or outlet tubes can be added to the pipe fitting as required. As another example, the size and shape of the throat opening, and thus the size of the throat section, can be modified as needed to fit particular applications. Additionally, the radius of curvature of the throat section can also be modified. It should also be noted that the tee fitting of the present invention can be beneficially used in any piping system transporting a liquid/solid mixture. These and other deviations from the particular embodiments shown will be apparent to those skilled in the art, particularly in view of the foregoing disclosure.

I claim:

1. A pipe fitting comprising:
a run tube including a cylindrical wall defining a first end opening, a second end opening, and an elongated throat opening;
a branch tube fitting defining a fluid passage; and
a tapered throat section coupled between said elongated throat opening and said branch tube fitting.

2. A pipe fitting according to claim 1, wherein said first end opening is parallel to said second end opening.

3. A pipe fitting according to claim 1, wherein said throat opening extends a majority of the length of said run tube.

4. A pipe fitting according to claim 1, wherein at least one of said first end opening and said second end opening include a fitting for coupling said at least one of said first end opening and said second end opening to a piping system.

5. A pipe fitting according to claim 4, wherein said fitting of said at least one of said first end opening and said second opening comprises a flange.

6. A pipe fitting according to claim 5, wherein said at least one of said first end opening and said second end opening defines a collar, said collar adapted to retain said flange about said at least one of said first end opening and said second end opening.

7. A pipe fitting according to claim 1, wherein a branch tube is interposed between said throat section and said branch tube fitting.

8. A pipe fitting according to claim 7, further including a collar around said branch tube and adapted to couple said branch tube fitting to a piping system.

9. A pipe fitting according to claim 1, wherein said branch tube fitting comprises a flange.

10. A pipe fitting according to claim 1, wherein the cross sectional area of said elongated throat opening is at least 1.25 times greater than the cross sectional area of said fluid passage.

11. A pipe fitting according to claim 1, wherein said pipe fitting is adapted for use in a winery piping system.

12. A pipe fitting according to claim 11, wherein said pipe fitting is fabricated from stainless steel.

13. A pipe fitting according to claim 1, wherein:
said throat section includes a front wall and a back wall; and
said front wall and said back wall are tangentially coupled to said run tube.

14. A pipe fitting according to claim 13, wherein:
a branch tube is interposed between said throat section and said branch tube fitting; and
said front wall and said back wall are coupled to said branch tube.

15. A pipe fitting according to claim 13, wherein said front wall and said back wall are flat.

16. A pipe fitting according to claim 1, wherein said throat section includes a first side wall and a second side wall, said first side wall and said second side wall each defining a radius of curvature between said run tube and said branch tube fitting.

17. A pipe fitting according to claim 16, wherein:
said fluid passage is generally circular; and
said radius of curvature is at least 1.5 times the diameter of at least one of said first end opening, said second end opening, and said fluid passage.

18. A pipe fitting comprising:
a body defining a generally triangular inner chamber; and
three connectors, each coupled to a respective corner of said triangular chamber for providing fluid communication with said chamber.

19. A pipe fitting according to claim 18, wherein said body defines three fluid passages, each of said fluid passages in fluid communication with a respective one of said connectors.

20. A pipe fitting according to claim 19, wherein said body defines a radius of curvature between two adjacent ones of said fluid passages.

21. A pipe fitting according to claim 20, wherein:
each of said fluid passages is generally circular; and
said radius of curvature is greater than 1.5 times the diameter of a largest one of said fluid passages.

22. A pipe fitting according to claim 20, wherein said radius of curvature is infinite.

23. A pipe fitting according to claim 18, wherein a tube is interposed between at least one of said connectors and an associated corner of said chamber.

24. A pipe fitting according to claim 18, wherein each of said connectors comprises a flange.

25. A pipe fitting according to claim 24, wherein each of said flanges is retained by a collar coupled to said body.

26. A pipe fitting comprising:
a tube having a cylindrical wall defining a first end opening, a second end opening, and a throat opening;
a connector defining a fluid passage; and
a throat section coupled between said throat opening and said connector; and
wherein a cross-sectional area of said throat opening is at least 1.25 times greater than a cross-sectional area of said fluid passage.

27. A pipe fitting according to claim 26, wherein said cross-sectional area of said throat opening is at least two times greater than said cross-sectional area of said fluid passage.

28. A pipe fitting according to claim 26, wherein said cross-sectional area of said throat opening is at least three times greater than said cross-sectional area of said fluid passage.

29. A pipe fitting according to claim 26, wherein said throat opening is elongated.

30. A pipe fitting according to claim 26, wherein said throat section, in combination with a portion of said tube, forms a generally triangular inner chamber.

31. A pipe fitting according to claim 26, wherein at least one of said first end opening and said second end opening include a connector for connecting said at least one of said first opening and said second opening to a piping system.
